(19) United States
(12) Patent Application Publication
(10) Pub. No.: US 2019/0228378 A1
(43) Pub. Date: Jul. 25, 2019

(54) INTELLIGENT TARGETING OF FILES NEEDING ATTENTION

(71) Applicant: MICROSOFT TECHNOLOGY LICENSING, LLC, Redmond, WA (US)

(72) Inventors: John Lincoln DeMARIS, Seattle, WA (US); Daniel Friel HOLME, Redmond, WA (US); Christopher Francis McNULTY, Bellevue, WA (US); Ian David STORY, Kent, WA (US)

(21) Appl. No.: 15/879,406

(22) Filed: Jan. 24, 2018

(51) Int. Cl. G06Q 10/10; H04L 29/08; G06F 17/30; G06F 17/18

(52) U.S. Cl. CPC G06Q 10/10; G06F 17/18; G06F 17/30699; H04L 67/22

(57) ABSTRACT

One goal of the disclosed embodiments is to improve user engagement, e.g. increasing the number of documents from a group of documents that are read, reviewed, and/or modified. Patterns of inaction are identified based on user inactivity, both in comparison to a group that has received the same group of documents, and as an individual who has received a request regarding a document from another user. When a user crosses a threshold of inactivity, attempts to engage with specific documents are initiated. In one embodiment, promoting content includes displaying links to content in novel ways, including adding links to promoted content to existing content lists located in existing application software, such as a recently opened file list, or adding promoted content in places where a user is likely to see the recommendation while completing a previous task, such as at the bottom of a word processing document.

### BACKGROUND

Information workers are frequently asked to interact with documents to perform their job functions. Often times, workers are prompted to read, edit, review, or otherwise interact with a document or a collection of documents. When a group of workers are prompted to interact with the collection of documents, it is common for one or more workers to lag behind the others. The situation may be a mere inconvenience or a significant safety or security concern if one or more members of a group have not reviewed and updated safety or security protocols.

Even if it is known that a worker has lagged in interacting with a document or collection of documents, it remains a challenge to effectively prompt the worker to view the document(s). For example, simply retrying the previous methods of providing the document(s) may lead to the same result—failure to interact with the document(s). Even if a content management system offers a task list that shows items needing the worker's attention, this still requires the worker to go to a “special place” to view the information.

It is with respect to these and other considerations that the disclosure made herein is presented.

### SUMMARY

One goal of the disclosed embodiments is to improve engagement across collections of documents. While documents and collections of documents are discussed throughout this disclosure, any type of content is similarly contemplated. For example, individual websites or collections of websites, emails, audio, video, etc., may be analyzed and acted upon similarly.

One key distinction of the disclosed embodiments is targeting documents based on patterns of inaction, as opposed to targeting based on patterns of action. Targeting based on a pattern of action tries to make one user similar to another. For example, if users A and B have purchased similar items on an online shopping site, but user B has purchased a few additional items, targeting based on the pattern of action may suggest the additional items to user A. Another example of targeting based on patterns of action is to analyze a group of people and suggest content to a member of the group based on the actions of other people in the group. For example, if some members of a product team start to read a particular blog post, a system of targeting based on patterns of action may recognize this trend and recommend the blog post to other members of the team.

In contrast, targeting based on patterns of inaction, as disclosed herein, determines when inactivity of a user is statistically significantly different from the inactivity of other users. For example, a human resources executive might create a bundle of content he/she wants a group of people, such as new hires, to review. The documents may be related to benefits enrollment for the year, an event which has a deadline. As the new hires review the documents, some individuals may stand out for not reviewing the documents, or for lagging significantly behind in reviewing the documents. Crossing a threshold of difference of inactivity signals a pattern of inaction, triggering attempts to remediate by promoting content to the user. In one embodiment, promoting content includes displaying links to content in novel ways, as discussed herein. In one embodiment, the threshold may be a 90% confidence level that an individual is at least 2 standard deviations behind the engagement of the group (e.g. a Z-score of 1.64), but other confidence levels, standard deviations, and Z-scores are similarly contemplated.

A threshold may be made lower (i.e. easier to trigger) if a priority of the documents that haven't been interacted with is high. For example, security related documents may be assigned a higher priority, and so a lower threshold would be applied, rather than a weekly status update. Similarly, as a priority of a document changes, the associated threshold may change inversely. For example, as a deadline approaches, urgency for the documents to be reviewed may increase, causing the threshold of difference to be lowered.

One goal of the disclosed embodiments is to avoid false signal activity, which may become annoying, causing a user to disable the feature and lose all benefit. In one embodiment, false signal activity is avoided by using a high threshold, e.g. a 90% confidence level that a user has viewed at least two standard deviations fewer documents. However, other facts may be considered, such as a current time zone of a user. If a member of a team is located many time zones away, a lag in engagement may be caused by different sleep patterns. In one embodiment, different time zones are accounted for by allowing users a minimum amount of time from the beginning of their workday to engage with the documents before a signal is generated.

Similarly, even if all members of the team are located in the same geographic area, team members may be given a minimum amount of time to engage with the documents before a signal is generated, even if everyone else on the team has already interacted with the documents. For example, if a ten member team has a new security protocol distributed, and nine of the team members have read it within two minutes of distribution, the 10^{th} team member may be given an hour to read the document before further action is taken. The amount of time allowed is customizable and may depend on a priority of the documents.

Another goal of the disclosed embodiments is to adjust the threshold for identifying inactivity based on how frequently a user opens suggested documents. For example, users who respond to suggestions more frequently than an average user may derive more benefit from a suggestion, and as such would appreciate receiving suggestions more frequently. In this case, the threshold for detecting inactivity could be lowered, thereby increasing the number of suggestions presented compared to an average user. At the same time, users who are less likely act on a suggestion may have their threshold for detecting inactivity increased, thereby decreasing the number of suggestions presented.

Other mechanisms are contemplated for determining when a user hasn't interacted with a document soon enough, such as when one user has asked another user to edit or comment on a document. For example, a first user may initiate a process that requests a second user to comment on or complete a section of a document. The request may or may not be associated with a deadline. The request may be made only of the second user, i.e. there is no group to compare the second user's engagement with. Based on factors such as content type, amount of time outstanding, etc., a grace period is determined after which the inaction will be signaled and the corresponding content promoted. A similar mechanism may be employed when the first user solicits feedback on a document from the second user.

Other mechanisms for determining inaction don't involve person-to-person targeting. For example, a user uploads a file to a location that requires metadata, but the user has not filled out the metadata. Or, the user checks out a file from a version control system and leaves it checked out for a long time (beyond a threshold). Or, a user uploads a file that contains sensitive information to a non-secure location. Once one of these conditions is recognized, the appropriate content can be promoted to remedy the situation.

Once a user has been identified as inactive with regard to a document, embodiments promote the document to the user in novel ways. As discussed above, existing solutions such as task lists are deficient in that a user must know the task list exists, the user must know how to find the task list, and the user must think to use the task list during an otherwise busy day. One goal of the disclosed embodiments is to present the document (or a link thereto) in the user's path of normal usage, thereby increasing the likelihood that the user will be made aware of the document. This is motivated by the insight that the user hasn't interacted with the document as it was originally provided, and so merely providing the same document via the same mechanism a second time is less likely to be effective.

For example, upon a user viewing the end of a word processing document, one embodiment displays a “documents to view next” signal. A “Documents to view next” prompt may be placed after the last piece of content in the word processing document, and may include an in-line list of documents, such that the user's eye is naturally directed to the list. Additionally or alternatively, the list may appear in a task pane or other window adjacent to the end of the word processing document.

Another embodiment inserts or appends the document, or a link thereto, to a file listing. For example, a link to the document may be appended to the contents of a folder, the contents of a collaborative repository, or the user's “recent files list”. In this way, a user is presented with one or more documents that have triggered an inactivity threshold at a time when the user has finished one task and is looking to begin another.

In another embodiment, one or more documents that have triggered an inactivity threshold, or links thereto, are inserted into an email message. For example, the documents may be inserted into/appended to a list of documents attached to an email. If no actual documents are attached to an email, the promoted content would appear where attachments could be found. Additionally or alternatively, the documents may be referenced at the end of the email, similar to the word processing document embodiment discussed above.

In one embodiment, multichannel distribution is employed, using two or more of the above-mentioned techniques of content promotion. In this embodiment, when a user does interact with one of the channels, the content will no longer be promoted by the other channels.

Documents presented in the user's path of normal usage may be sorted or filtered based on the mechanism through which they are provided, the surrounding content, the urgency of viewing the documents, and the like. For example, one mechanism is to display a list of “documents to view next” at the end of a word processor. In this case, priority may be given to other word processing documents, due to the affinity between word processing documents and promoting documents in a word processor. Similarly, if the mechanism is embedding a list of “documents to view next” as attachments in an email application, higher priority may be assigned to a document that was originally distributed by email due to the affinity between email applications and a document that was originally distributed by email. For example, a word processing document that was distributed over email may be prioritized over a spreadsheet that was distributed over a document management system.

With regard to surrounding content, priority may be given to documents that were authored by or distributed by the author of the surrounding content. For example, if the user is viewing an email thread, and a number of documents are identified that the user has been inactive towards, and one of the documents was authored by or distributed by one of the participants in the email thread, that document will be prioritized. Similarly, priority may be given to documents that are referenced by the surrounding content. For example, an email reminding users to read a security bulletin may cause that security bulletin to be prioritized in the list of files to view next.

With regard to the urgency of viewing documents, documents may be listed in a priority order. The priority may be based inversely on a degree of difference between the inactivity of the user and the inactivity of the group. Additionally or alternatively, the priority may be based inversely on an amount of time left before an approaching deadline (i.e. a time closer to the deadline being more urgent).

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter or a sequence of letters to refer to each individual item. Generic references to the items may use the specific reference number without the sequence of letters.

FIG. 1 shows a plurality of users interacting with documents provided by a document management system.

FIG. 2A shows an initial state of a table indicating who on a team of users has interacted with which of a plurality of documents.

FIG. 2B shows a table indicating who on a team of users has engaged with which of a plurality of documents after some of the users have begun to interact with some of the documents.

FIG. 2C shows a table indicating who on a team of users has engaged with which of a plurality of documents after one of the users has completed interacting with all of the documents.

FIG. 2D shows a table indicating who on a team of users has engaged with which of a plurality of documents after most of the users have completed interacting with most of the documents.

FIG. 3 shows a file open dialog in which content is being promoted in a recent documents list.

FIG. 4 shows content being promoted at the bottom of a document as displayed in a word processing application.

FIG. 5 shows content being promoted as an attachment to an email.

FIG. 6 is a flow diagram of an example method for intelligent targeting of files needing attention.

FIG. 7 is a computer architecture diagram illustrating an illustrative hardware and software architecture for a computing system capable of implementing aspects of the techniques and technologies presented herein.

### DETAILED DESCRIPTION

The following Detailed Description describes methods and systems for intelligent targeting of files needing attention.

As used herein, “content” refers to a document, spreadsheet, email, text message, web page, video, audio, image, or the like, or a portion thereof. The term “document” is used throughout this disclosure for brevity and clarity, but it is understood that other types of content are similarly contemplated.

As used herein, “interaction” refers to exposure to and/or modification of a piece of content by a user. The terms interaction and engagement may be used interchangeably. Interaction may be observed by noting that the user has opened a document. In other embodiments interaction may require observing that the user has scrolled through the document at a pace consistent with reading the document. Interaction may be measured locally on a client computing device, or remotely by a server computer that provided the document for display.

As used herein, “inaction” refers to a failure to interact with, or the absence of interaction with, a piece of content.

As used herein, “patterns of inaction” refers to markedly lower levels of interaction with a plurality of documents as compared to an average level of interaction with the plurality of documents. Patterns of inaction are often measured in a number of standard deviations from levels of interaction observed by other members of a team.

As used herein, “document management system” refers to a piece of software, typically running on a server computer, used to track, manage and store documents.

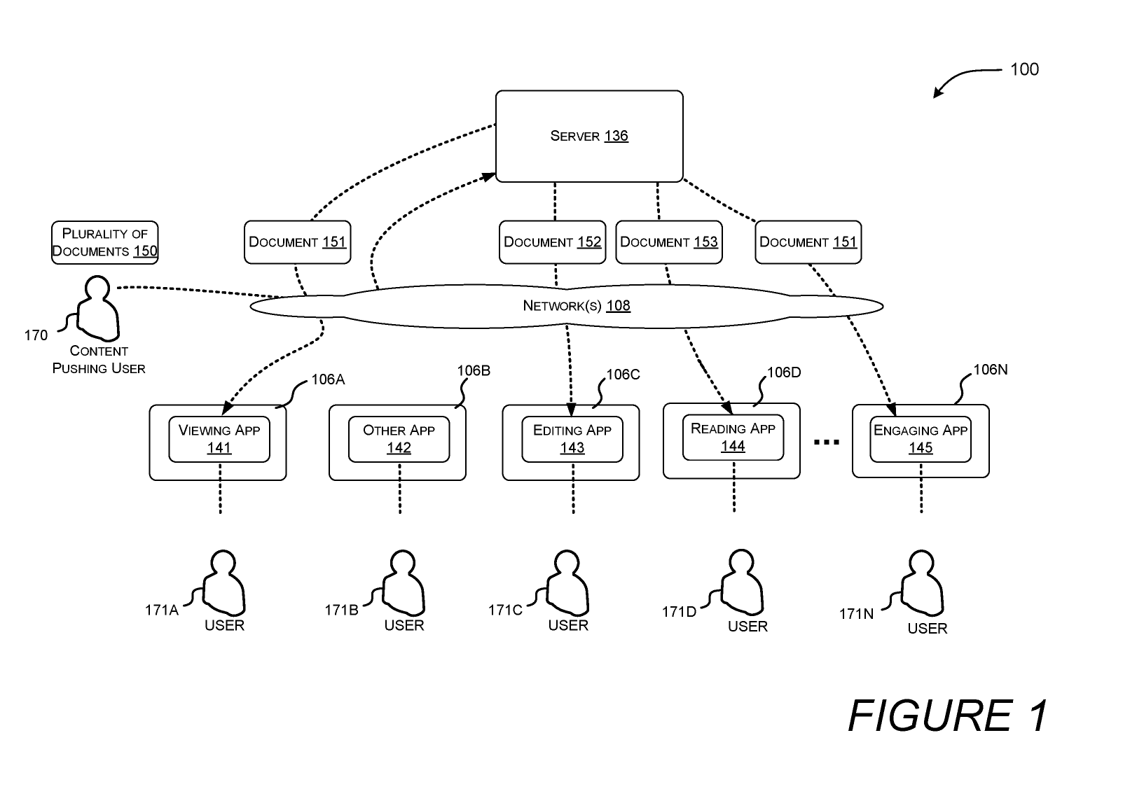

Turning now to FIG. 1, illustrated are portions of a system 100 (also referred to herein as a “document management system”) used to target files needing attention. In one embodiment, content pushing user 170 generates, identifies, collects, or otherwise bundles a plurality of documents 150 containing at least documents 151, 152, 153, and the like. Content pushing user 170 has targeted a team of users including user 171A, 171B, 171C, 171D, and 171N to distribute the documents to. Users 171A through 171N may be members of a product team, a family, a company, or any other organization of individuals. Each of Users 171A through 171N are operating one of computers 106A-106N, respectively, which are connected to server 136 through network 108.

In one embodiment, each of the users 171A through 171N is using an application on one of computers 106A through 106N to view or otherwise interact with one of documents 151-153. For example, user 171A is using viewing app 141 to view document 151. User 171B is using another app 142, but has not interacted with any of documents 151, 152, or 153. User 171C is using editing app 143 to edit document 152. User 171D is using reading app 144 to read document 153. A reading app may perform text-to-speech functionality and read the document out loud to the user. User 171N is using computer 106N to execute engaging app 145 to engage with document 151. As users 171A-171N view, edit, or otherwise interact with documents 151-153, records of these interactions are stored and processed locally and/or by server 136 to identify users who have not interacted with a threshold percentage of documents.

In one embodiment, for each user, a percentage of documents that have been interacted with is calculated. In one embodiment, all types of interactions are given equal weight, such that viewing, editing, reading, commenting, and any other type of interaction is treated equally when determining the percentage. However, in another embodiment, types of interactions deemed more intense, e.g. editing or commenting, are given more weight.

In one embodiment, if one of the users 171A through 171N fails to interact with a threshold percentage of documents, that user may be targeted for content promotion as described herein. For example, if users 171A and 171C through 171N are determined to have interacted with an average of two-thirds (“⅔”) of the plurality of documents 150, while user 171B is determined to have interacted with none of the documents, user 171B may be targeted for content promotion, and specifically for content promotion of documents 151-153.

In one embodiment, whether a threshold has been crossed beyond a certain standard deviation of inactivity, with a predefined confidence value, is determined when the following equation evaluates to a positive number (i.e. >0):

$${I}_{μ} - Z ( \frac{E}{\sqrt{n}} ) - {i}_{μ} > 0$$

Where:
Iμ refers to the average content engagement for a user population—i.e. what is the total number of views divided by the total possible number of document views.
Z refers to the normal distributed statistical score for a given confidence interval. For example, a statistical score could be calculated with a given confidence of 90%.
E refers to σI, the standard deviation (σ) of interactivity (I) of all users with respect to all documents.
n refers to the number of users that have been asked to engage with the documents.
iμ refers to an average engagement for the chosen user—i.e. what percentage of the documents has a given user interacted with.

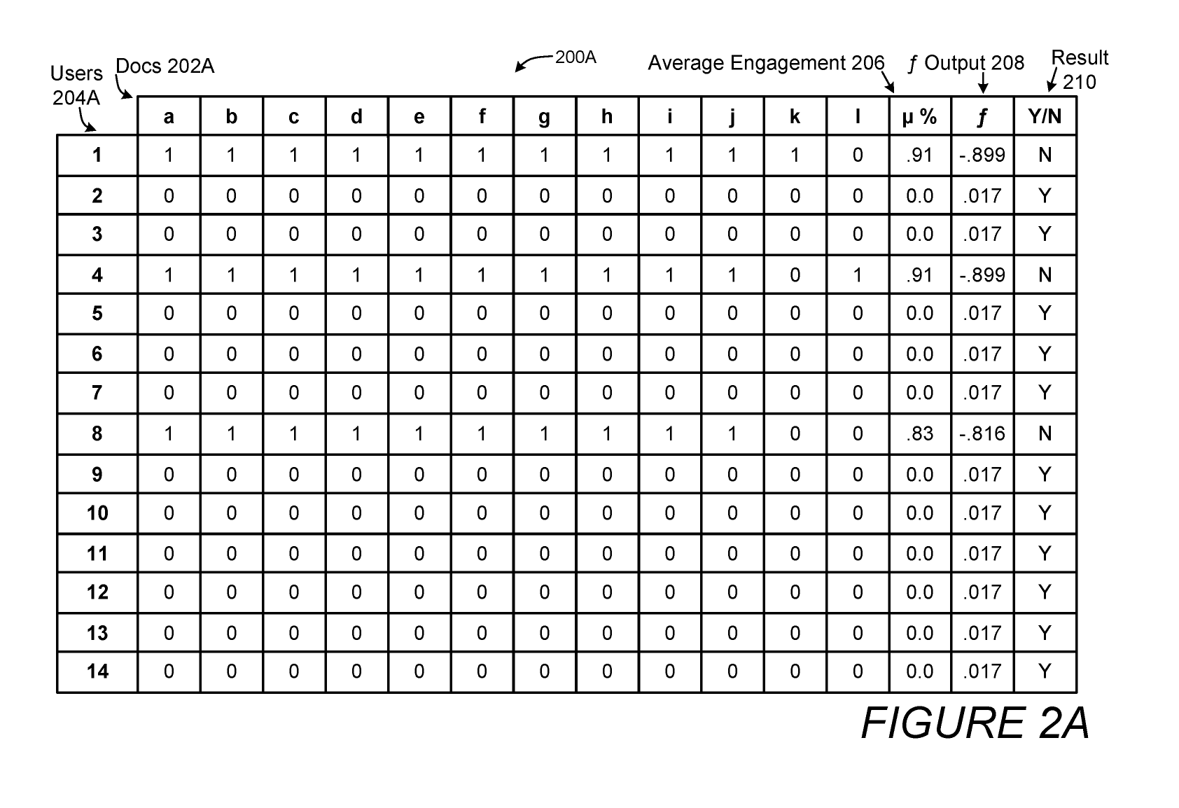

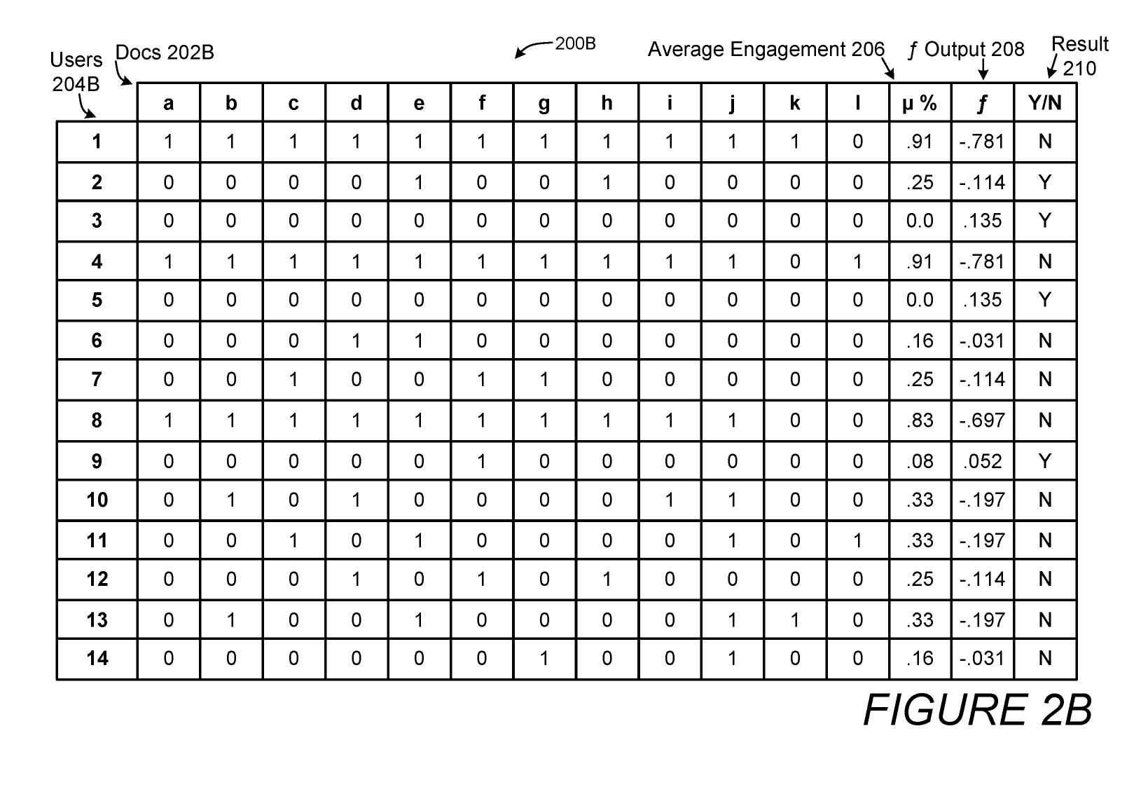

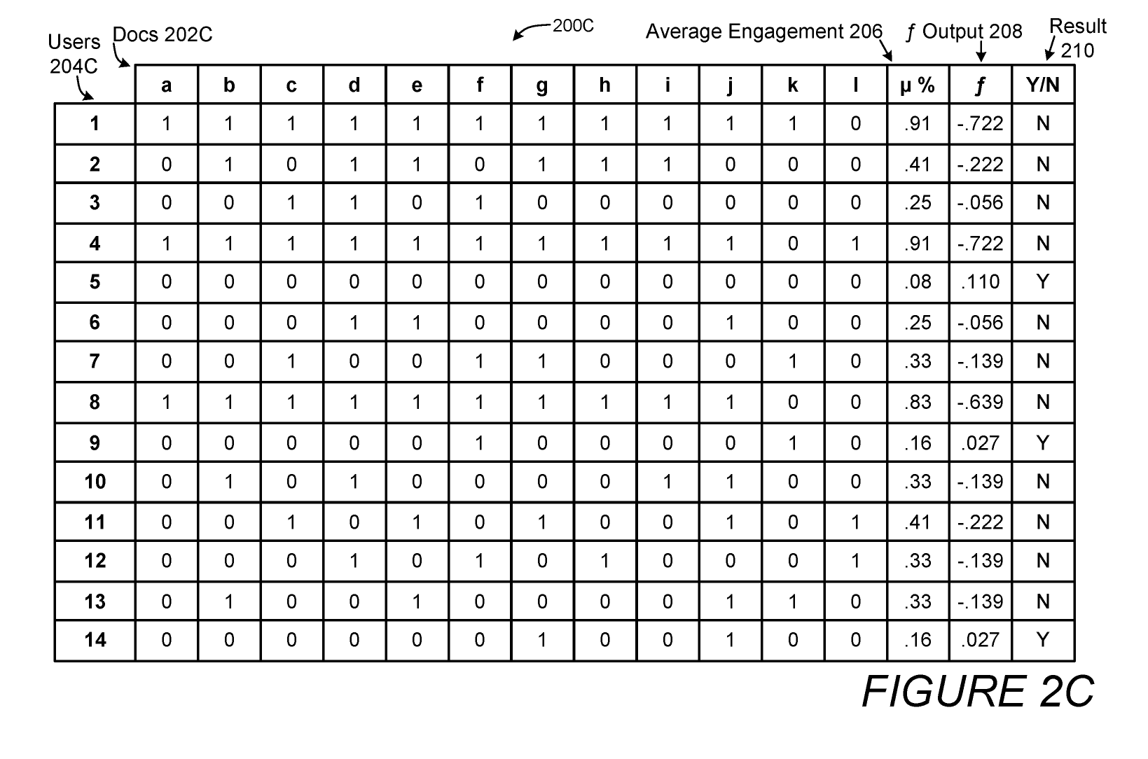

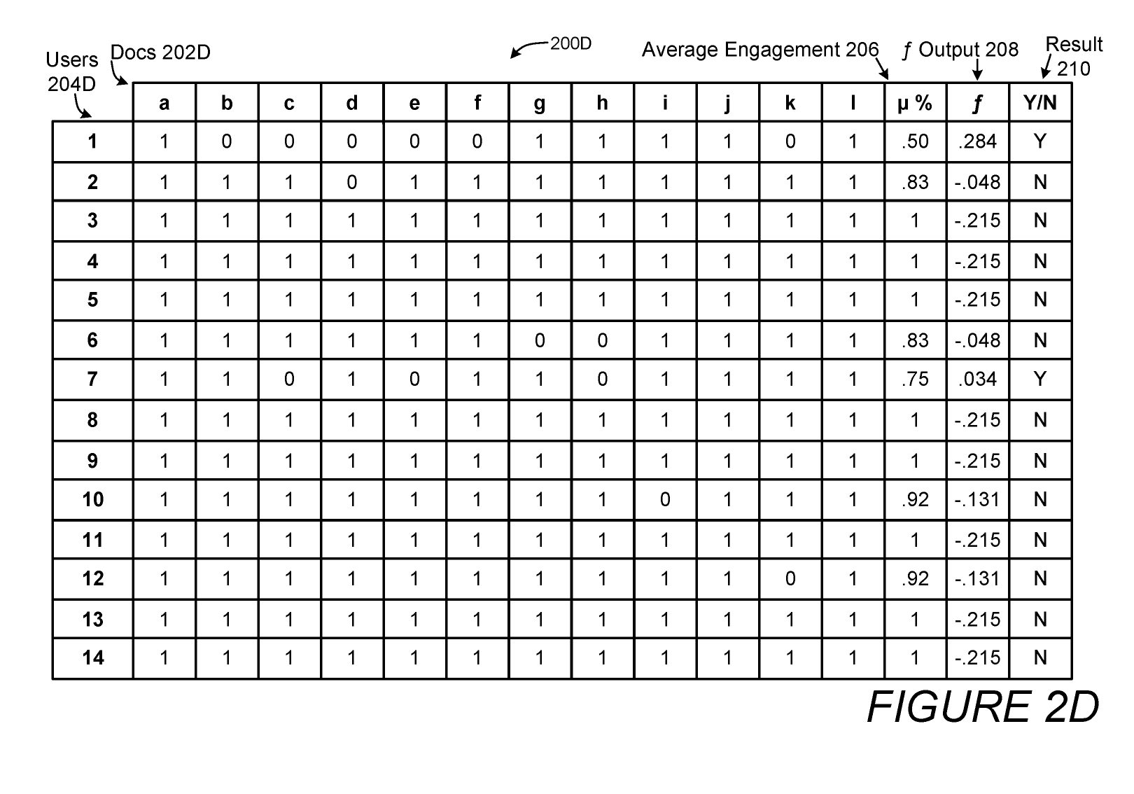

Turning now to FIG. 2A, illustrated is a table 200A indicating which users 202A(A) 202A(L) have interacted with which of a plurality of documents 204A(1)-204A(14). In one embodiment, the means by which the documents were interacted, or the number of times a document was interacted with, with is inconsequential, and so the interaction is recorded as a Boolean value: ‘1’ indicating that the document was interacted with, while ‘0’ indicates that it wasn't interacted with. In this embodiment, users 204A(1), 204A(4), and 204A(8) have interacted with most of the documents, as indicated by high average engagements 206A of 91%, 91%, and 83%, respectively. In contrast, the remaining users lag behind, having failed to engage with any documents. The number of documents and the number of users depicted in FIGS. 2A-2D is for illustrative purposes only, and many more or less documents and users are similarly contemplated.

By applying the equation discussed above with reference to FIG. 1, the associated outputs are displayed in column 208A, with the decision whether to initiate prompting displayed in column 210A. In this example, users 204A(1), 204A(4), and 204A(8) have function outputs 208A that are negative (i.e. below zero), and so they will not be prompted. However, the remaining users, who have each fallen below the threshold based on the average number of documents they have viewed (iμ) each have function outputs 208A that are positive (i.e. greater than or equal to zero), and so they will begin receiving prompts as discussed below. This is but one embodiment, and users who have engaged with one or more documents may still be deemed sufficiently behind as to warrant a prompt, as discussed below. Having viewed zero documents is not a necessary or sufficient condition for triggering a prompt.

Turning now to FIG. 2B, illustrated is a table 200B indicating which of a plurality of documents 204B(A)-204B(L) have been interacted with by which of a team of users 204B(1)-204B(14). This embodiment is a continuation of FIG. 2A, as the users interact with additional documents. In this embodiment, enough users have begun to engage with enough documents that the number of users receiving prompting has reduced to 3, as indicated by columns 206B, 208B, and 210B. Specifically, for this example of users and their interactions, any user who has engaged with 16% of more of the documents is deemed to no longer receive prompting.

Turning now to FIG. 2C, illustrated is a table 200C indicating which of a plurality of documents 204C(A)-204C(L) have been interacted with by which of a team of users 204C(1)-204C(14). This embodiment is a continuation of FIG. 2B, as the users interact with additional documents. In this embodiment, user 204C(2) has, perhaps in response to content promotion triggered by the state of FIG. 2B, interacted with 41% of the documents, up from 25% of documents in FIG. 2B, and 0% of documents in FIG. 2A. However, user 204C(14), who had stopped receiving prompting in FIG. 2B, has fallen below the threshold and begun to receive prompting again. This has occurred even though user 204C(14) hasn't interacted with more or fewer documents. However, other members of the group have interacted with additional documents, changing the threshold, and so relative to the group, user 204C(14) has fallen below the new threshold, and as a result will receive prompting. In another embodiment, user 204C(14) may have interacted with additional documents and still fallen below the new threshold.

Turning now to FIG. 2D, illustrated is a table 200D indicating which of a plurality of documents 204D(A)-204D(L) have been interacted with by which of a team of users 204D(1)-204D(14). This embodiment is a continuation of FIG. 2C, as the users interact with additional documents. In this embodiment, all of the users have interacted with almost all of the documents. In this scenario, document promotion for the current plurality of documents is considered complete. However, in other embodiments, a 100% completion rate for all of the users may be necessary, while other definitions of a successful document promotion may include a smaller percentage of users having interacted with a smaller percentage of documents, e.g. 80% of users having interacted with at least 75% of the documents.

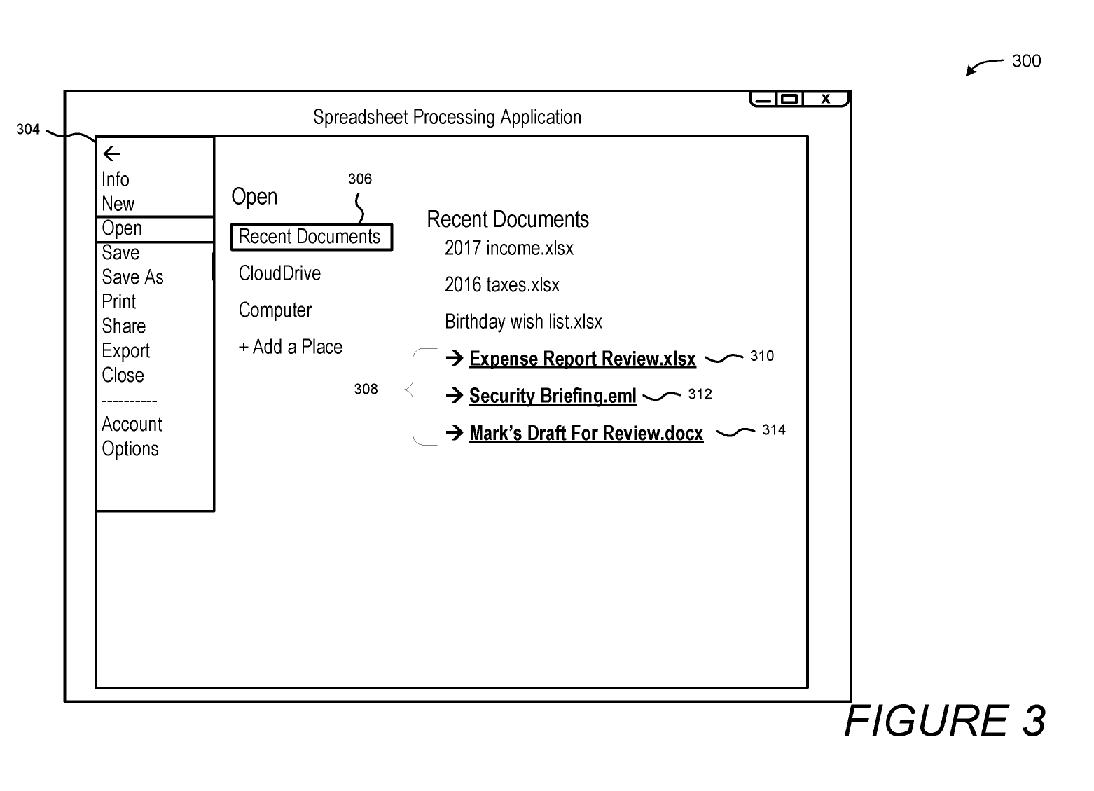

Turning now to FIG. 3, illustrated is a spreadsheet processing application 300, including a file open dialog 304 in which documents 308 are being promoted in a recent documents list 306. In one embodiment, “Expense Report Review.xlsx” 310, “Security Briefing.eml” 312 and “Mark's Draft For Review.docx” 314 are appended to/inserted into the recent documents list 306. In this way, when a user is about to open a document, potentially to begin a new task, the user is reminded to open one of the promoted documents.

In one embodiment, the user is enabled to view why a document is included in the list, e.g. by hovering over the document to view statistics about the associated plurality of content, an approaching deadline, a request to edit the file, etc. Additionally or alternatively, “Expense Report Review.xlsx” is prioritized at the top of the list because the list is being displayed in a spreadsheet processing application and “Expense Report Review.xlsx” is a spreadsheet document.

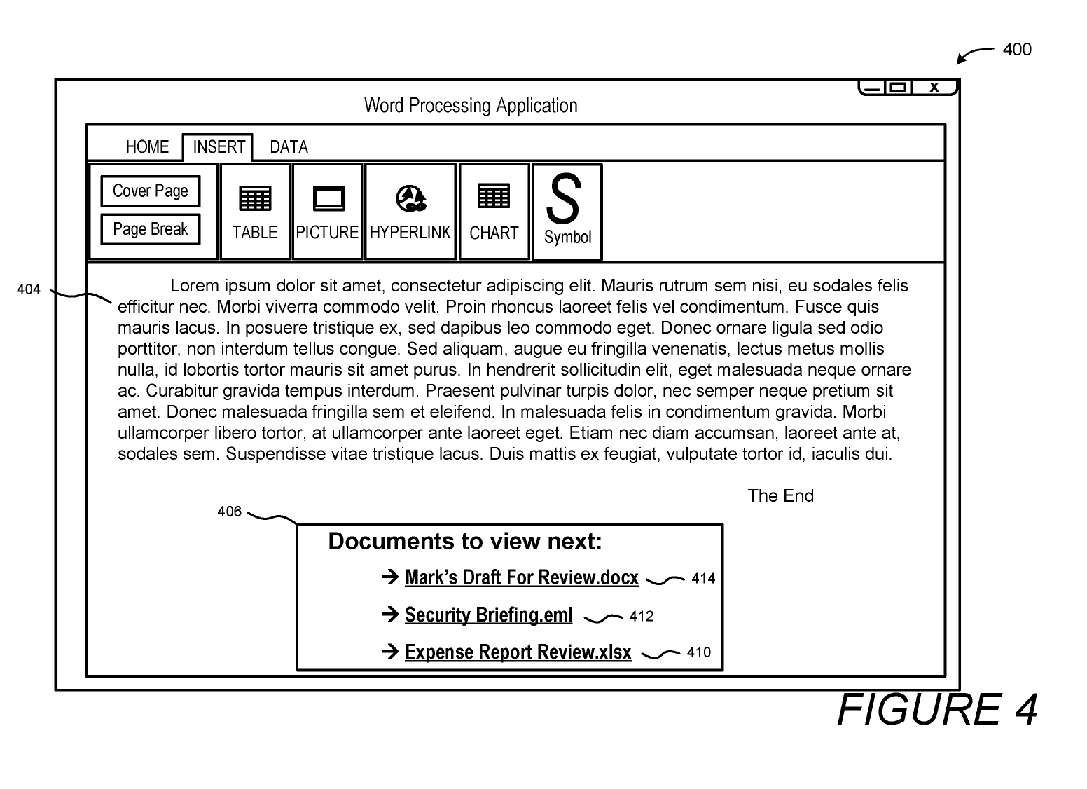

Turning now to FIG. 4, illustrated is a word processing application 400, including a document 404 and a “documents to view next” promotion 406 displayed at the end of document 404. In this way, as a user finishes reading/editing document 404, other documents that haven't been read/edited are listed. For example, “Mark's draft for review.docx” 414, “Security briefing.eml” 412 and “Expense report review.xlsx” 410 are listed for convenient access by a user who has just finished reading document 404. In one embodiment, “Mark's draft for review.docx” 414 is given priority (e.g. is listed first) based on the affinity between the document type (“.docx”) and the application type (word processor).

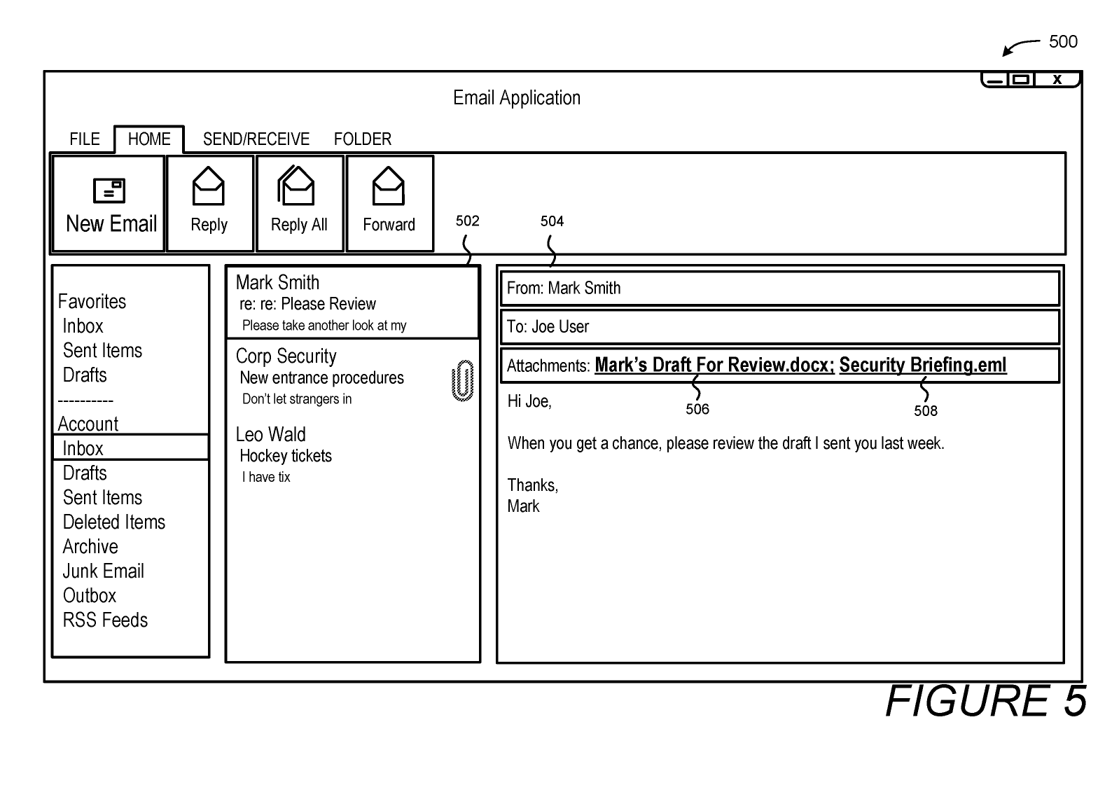

Turning now to FIG. 5, illustrated is an email application 500 including inbox 502 and email message 504. Email message 504 includes a list of attachments, which in this case have been populated by promoted documents, e.g. “Mark's draft for review.docx” 506 and “Security briefing.eml” 508. i.e. “Mark's draft for review.docx” 506 and “Security briefing.eml” 508 are not traditional attachments, however these promoted documents may be listed along-side actual attachments.

In this illustration, email message 504 is one of a chain of emails in which Mark Smith has asked Joe User to review a draft document. Of all the documents that could have been promoted, “Mark's Draft For Review.docx” is at the top because the author of the email (“Mark Smith”) is also the author of “Mark's Draft For Review.docx”. In another embodiment, “Mark's Draft For Review.docx” is prioritized because it had been attached to an email in the thread.

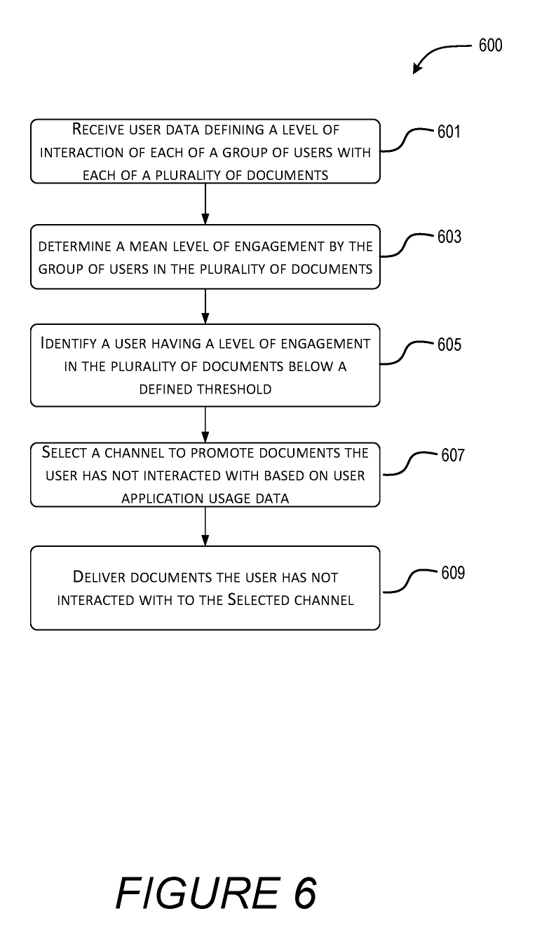

FIG. 6 is a flow diagram of an example method 600 for intelligent targeting of files needing attention. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

At block 601, a system (e.g., server 136) receives user data defining a level of interaction of each of a group of users with each of a plurality of documents. Examples of this type of data are depicted in FIGS. 2A-2D. The level of interaction may refer to a percentage of documents that have been interacted with, e.g. column 206A, where each interaction is treated equally, regardless of the type or frequency or duration of the interaction. However, a degree of interaction may, in another embodiment, be considered when determining a level of interaction, which may in turn affect whether a user is deemed to have engaged with the plurality of documents enough to avoid being prompted. For example, a document that was edited may be deemed interacted with to a greater degree than a document that was merely read. Similarly, a document that was scrolled through slowly, at a reading pace, may be deemed interacted with to a greater degree than a document that was skimmed or merely opened without being scrolled.

In one embodiment user data is captured by applications executing on a user's client device. For example, spreadsheet processing application 300, word processing application 400, or email application 500 may note when a document has been interacted with and/or the extent to which the document has been interacted with, and report data indicating as much to server 136. Additionally or alternatively, the user interaction data is captured by server 136 as documents are downloaded for display on a user's client computer, or as documents with modifications are uploaded from the user's client computer to server 136.

In one embodiment, the plurality of documents includes a new set of manuals for a flight deck of an airline crew. For example, there are 10 documents in the plurality of documents, and there are 20 pilots who work for the particular airline. Data received at block 601 indicates which of the pilots have reviewed which of the new set of manuals, with the goal of determining what documents haven't been interacted with and/or what people haven't interacted with the set of manuals.

At block 603, a threshold level of engagement by the group of users is determined for the plurality of documents. In one embodiment, the threshold is determined by calculating the

$${I}_{μ} - Z ( \frac{E}{\sqrt{n}} )$$

terms of the equation discussed above in conjunction with FIG. 1.

First, the group interactivity score I_{μ} may be calculated by dividing the number of document views by any of the team members by the number of potential document views. For example, if half of a team has viewed half of the documents, then I_{μ}=25%.

Next, the

$$Z ( \frac{E}{\sqrt{n}} )$$

term is calculated. In one embodiment, the threshold level of engagement is determined to a given confidence level, e.g. to a 90% confidence level. The confidence level can be used to determine Z, an area under the standard normal curve that corresponds that confidence level (e.g. 1.64 for 90%). Z is multiplied by the standard deviation E of the number of views of each user, and divided by the square root of the number of users.

In one embodiment, the result of

$${I}_{μ} - Z ( \frac{E}{\sqrt{n}} )$$

is the threshold value applied below to determine if an individual user should be prompted to view additional documents.

At block 605, a user having a level of interaction in the plurality of documents below the defined threshold is identified. In other words, a user lagging behind his or her peers in interacting with the plurality of documents is identified. In one embodiment the user is identified when the user's engagement with the plurality of content is statistically significantly different from other users' interactions. In one embodiment, the average engagement for a given user is subtracted from the threshold defined above in conjunction with block 603. In one embodiment, if the result is greater than or equal to zero, the user is deemed to lag other team members enough to warrant prompting. However, if the result is less than zero, the user is deemed to have viewed a sufficient number of documents that prompting is to be avoided.

One goal of the various embodiments is to avoid promoting content to a user for small or transient differences in engagement. For example, it may be that some, even many, of the users in the group respond to the initial presentation of the plurality of documents. Without safeguards, a user who did not immediately review the documents could be targeted, when instead an initial amount of time should be allowed to pass before contacting the user.

For example, if the group of users is typically located in a given time zone, but one of the users has been determined to be traveling, based on IP address, GPS data, calendar schedule information, or the like, that user may be compared against a threshold calculated based on a higher confidence level. Additionally or alternatively, the analysis may be delayed for users in other time zones so as to normalize when in the day the threshold comparison is made—e.g. everyone is evaluated at noon in their current time zone.

At block 607, a channel to promote documents the user has not interacted with is determined based on user application data. Continuing the example above, if 8 of the 10 pilots have great engagement, e.g. over 85% engagement, but two of the pilots have little to no engagement, one or more content channels are selected to promote documents that haven't been interacted with by the two pilots. In one embodiment, a channel for promotion is selected based on observations of how the target user spends his/her time. For example, if one of the user spends most of his/her time in email, the technique to engage with the user while in an email application may be selected. See, e.g., FIG. 5. However if the user spends most of his/her time using a web browser, mobile application or Microsoft Excel, content can be promoted in the appropriate channel, i.e. the user's email application, the user's web browser, or the user's Microsoft Excel application, as appropriate. In one embodiment, content can be promoted in a multitude of websites, applications, mobile apps, digital assistants, or the like.

At block 609, the documents which have not been interacted with are promoted over the one or more selected channels, as discussed above in conjunction with FIGS. 3-5. When a channel including links to open one or more promoted documents is displayed to a user, the user may click on or otherwise activate the links. When activated, a link may open the promoted content in another application window, another tab, or by opening the document in the application displaying the promoted content. As content is interacted with, tables such as discussed in conjunction with FIGS. 2A-2D are updated, and a new calculation of which documents to promote may be performed.

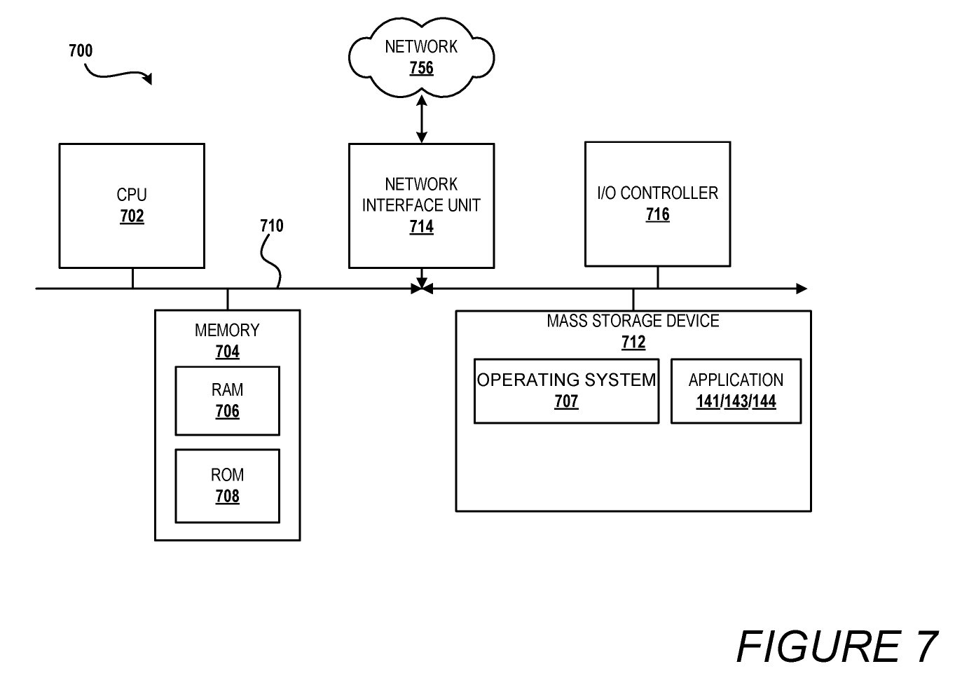

FIG. 7 is a computer architecture diagram that shows an architecture for a computer 700, e.g., the computers 106A-106N and/or server 136, capable of executing the software components described herein. The architecture illustrated in FIG. 7 is an architecture for a server computer, mobile phone, an e-reader, a smart phone, a desktop computer, a netbook computer, a tablet computer, a wearable device, a laptop computer, or another type of computing device suitable for executing the software components presented herein.

FIG. 7 shows additional details of an example computer architecture 700 for a computer, such as computers 106A-106N and the server 136 (FIG. 1), capable of executing the program components described herein. Thus, the computer architecture 700 illustrated in FIG. 7 illustrates an architecture for a server computer, a mobile phone, a PDA, a smart phone, a desktop computer, a netbook computer, a tablet computer, and/or a laptop computer. The computer architecture 700 may be utilized to execute any aspects of the software components presented herein.

The computer architecture 700 illustrated in FIG. 7 includes a central processing unit 702 (“CPU”), a system memory 704, including a random access memory 706 (“RAM”) and a read-only memory (“ROM”) 708, and a system bus 710 that couples the memory 704 to the CPU 702. A basic input/output system containing the basic routines that help to transfer information between elements within the computer architecture 700, such as during startup, is stored in the ROM 708. The computer architecture 700 further includes a mass storage device 712 for storing an operating system 707, other data, and one or more application programs 141, 143, and 144.

The mass storage device 712 is connected to the CPU 702 through a mass storage controller (not shown) connected to the bus 710. The mass storage device 712 and its associated computer-readable media provide non-volatile storage for the computer architecture 700. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes of the claims, the phrase “computer storage medium,” “computer-readable storage medium” and variations thereof, does not include waves, signals, and/or other transitory and/or intangible communication media, per se.

According to various configurations, the computer architecture 700 may operate in a networked environment using logical connections to remote computers through the network 756 and/or another network (not shown). The computer architecture 700 may connect to the network 756 through a network interface unit 714 connected to the bus 710. It should be appreciated that the network interface unit 714 also may be utilized to connect to other types of networks and remote computer systems. The computer architecture 700 also may include an input/output controller 716 for receiving and processing input from a number of other devices, including a keyboard, mouse, or electronic stylus (not shown in FIG. 7). Similarly, the input/output controller 716 may provide output to a display screen, a printer, or other type of output device (also not shown in FIG. 7).

It should be appreciated that the software components described herein may, when loaded into the CPU 702 and executed, transform the CPU 702 and the overall computer architecture 700 from a general-purpose computing system into a special-purpose computing system customized to facilitate the functionality presented herein. The CPU 702 may be constructed from any number of transistors or other discrete circuit elements, which may individually or collectively assume any number of states. More specifically, the CPU 702 may operate as a finite-state machine, in response to executable instructions contained within the software modules disclosed herein. These computer-executable instructions may transform the CPU 702 by specifying how the CPU 702 transitions between states, thereby transforming the transistors or other discrete hardware elements constituting the CPU 702.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 may include other types of computing devices, including hand-held computers, embedded computer systems, personal digital assistants, and other types of computing devices known to those skilled in the art. It is also contemplated that the computer architecture 700 may not include all of the components shown in FIG. 7, may include other components that are not explicitly shown in FIG. 7, or may utilize an architecture completely different than that shown in FIG. 7.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

### Example Clauses

Example Clause A, a method for intelligent targeting of files needing attention for the purpose of increasing a percentage of a plurality of files interacted with by a group of users, the method comprising: receiving data indicating whether each of the group of users has interacted with each of the plurality of documents; determining the percentage of documents that each of the group of users has interacted with based on the received data; calculating an average of the percentages; calculating a standard deviation of the percentages; identifying a user of the group of users that has interacted with a smaller percentage of the plurality of documents than a defined threshold; selecting a channel over which to promote a document that the user has not interacted with, wherein the channel includes a location within an application used by the user; displaying in the location within the application a list of links including the document that the user has not interacted with; receiving an activation of the link; and opening the document that the user has not interacted with in response to the activation of the link.

Example Clause B, the method of Example Clause A, wherein the threshold is the average of the percentages minus a normal distributed statistical score for a confidence interval.

Example Clause C, the method of Example Clause B, wherein the confidence interval is 90%.

Example Clause D, the method of any of Example Clauses B through C, wherein the threshold is determined based on the equation

$${I}_{μ} - Z ( \frac{E}{\sqrt{n}} ) ,$$

wherein I_{μ} refers to the average number of documents interacted with by the group of users, wherein

$$Z ( \frac{E}{\sqrt{n}} )$$

refers to the normal distributed statistical score for the confidence interval, wherein Z refers to an area under a standard normal curve corresponding to the confidence interval, wherein E refers to a standard deviation of documents interacted with by users of the group, and wherein \sqrt{n} refers to a square root of a number of users in the group of users.

Example Clause E, the method of Example Clause D, wherein identifying a user of the group of users is based on subtracting the percentage of documents viewed by the user from the threshold.

Example Clause F, the method of any of Example Clauses B through E, wherein the document includes any type of content, including spreadsheet, email, website, audio, video, and digital assistant.

Example Clause G, a computing device for targeting of files needing attention for the purpose of increasing a percentage of a plurality of files interacted with by a group of users, the computing device comprising: one or more processors; a memory in communication with the one or more processors, the memory having computer-readable instructions stored thereupon which, when executed by the one or more processors, cause the computing device to: receive data indicating whether each of a group of users has interacted with each of a plurality of documents; determine a percentage of documents that each of the group of users has interacted with based on the received data; calculate an average of the percentages; calculate a standard deviation of the percentages; identify a user of the group of users that has interacted with a smaller percentage of the plurality of documents than a defined threshold; select a channel over which to promote a document that the user has not interacted with, wherein the channel includes a location within an application used by the user; display in the location within the application a list of links including the document that the user has not interacted with; receive an activation of the link; and open the document that the user has not interacted with in response to the activation of the link.

Example Clause H, the computing device of Example Clause H, wherein the user of the group of users is identified based on a request sent to another user, wherein the request to the other user includes a document, and wherein the request to the other user is associated with a deadline.

Example Clause I, the computing device of any of Example Clauses G through H, wherein the channel includes an area at the bottom of a document.

Example Clause J, the computing device of Example Clause I, wherein the channel includes an entry added to a file list.

Example Clause K, the computing device of Example Clause J, wherein the file list includes a file folder.

Example Clause L, the computing device of Example Clause J, wherein the file list includes a recently opened files list.

Example Clause M, the computing device of Example Clause J, wherein the file list includes an email attachment list.

Example Clause N, the computing device of Example Clause H, wherein the list of links is in-line with another list in the document, and wherein the list of links is visually distinguished from the other list in the document.

Example clause O, a method for intelligent targeting of files needing attention, the method comprising: receiving data indicating whether each of a group of users has interacted with each of a plurality of documents; determining a percentage of documents that each of the group of users has interacted with based on the received data; calculating an average of the percentages; calculating a standard deviation of the percentages; identifying a user of the group of users that has interacted with a smaller percentage of the plurality of documents than a defined threshold; selecting a channel over which to promote a document that the user has not interacted with, wherein the channel includes a location within an application used by the user; displaying in the location within the application a list of links including the document that the user has not interacted with; receiving an activation of the link; and opening the document that the user has not interacted with in response to the activation of the link.

Example Clause P, the method of Example Clause O, wherein the received data includes a degree of interaction for each combination of user and document.

Example Clause Q, the method of any of Example Clauses O through P, wherein the degree of interaction is based on whether a document was read, scrolled to the bottom, edited, or added to.

Example Clause R, the method of any of Example Clauses O through Q, wherein the percentage of documents that each of the group of users has interacted with is modified to incorporate the degree of interaction.

Example Clause S, the method of any of Example Clauses O through R, wherein the list of links is prioritized based on a surrounding content in the application where the list of links is displayed.

Example Clause T, the method of any of Example Clauses O through R, wherein the list of links is prioritized based on an urgency, wherein the urgency is proportional to a proximity of a pending deadline.

While Example Clauses G through N are described above with respect to a computing device, it is also understood in the context of this disclosure that the subject matter of Example Clauses G through N can additionally and/or alternatively be implemented via a method, a system, and/or computer storage media.

1. A method for intelligent targeting of files needing attention for the purpose of increasing a percentage of a plurality of files interacted with by a group of users, the method comprising:
receiving data indicating whether each of the group of users has interacted with each of the plurality of documents;
determining the percentage of documents that each of the group of users has interacted with based on the received data;
calculating an average of the percentages;
calculating a standard deviation of the percentages;
identifying a user of the group of users that has interacted with a smaller percentage of the plurality of documents than a defined threshold;
selecting a channel over which to promote a document that the user has not interacted with, wherein the channel includes a location within an application used by the user;
displaying in the location within the application a list of links including the document that the user has not interacted with;
receiving an activation of the link; and
opening the document that the user has not interacted with in response to the activation of the link.

2. The method of claim 1, wherein the threshold is the average of the percentages minus a normal distributed statistical score for a confidence interval.

3. The method of claim 2, wherein the confidence interval is 90%.

4. The method of claim 2, wherein the threshold is determined based on the equation
$${I}_{μ} - Z ( \frac{E}{\sqrt{n}} ) ,$$
wherein I_{μ} refers to the average number of documents interacted with by the group of users, wherein
$$Z ( \frac{E}{\sqrt{n}} )$$
refers to the normal distributed statistical score for the confidence interval, wherein Z refers to an area under a standard normal curve corresponding to the confidence interval, wherein E refers to a standard deviation of documents interacted with by users of the group, and wherein \sqrt{n} refers to a square root of a number of users in the group of users.

5. The method of claim 4, wherein identifying a user of the group of users is based on subtracting the percentage of documents viewed by the user from the threshold.

6. The method of claim 1, wherein the document includes any type of content, including spreadsheet, email, website, audio, video, and digital assistant.

7. A computing device for targeting of files needing attention for the purpose of increasing a percentage of a plurality of files interacted with by a group of users, the computing device comprising:
one or more processors;
a memory in communication with the one or more processors, the memory having computer-readable instructions stored thereupon which, when executed by the one or more processors, cause the computing device to:
receive data indicating whether each of a group of users has interacted with each of a plurality of documents;
determine a percentage of documents that each of the group of users has interacted with based on the received data;
calculate an average of the percentages;
calculate a standard deviation of the percentages;
identify a user of the group of users that has interacted with a smaller percentage of the plurality of documents than a defined threshold;
select a channel over which to promote a document that the user has not interacted with, wherein the channel includes a location within an application used by the user;
display in the location within the application a list of links including the document that the user has not interacted with;
receive an activation of the link; and
open the document that the user has not interacted with in response to the activation of the link.

8. The computing device of claim 7, wherein the user of the group of users is identified based on a request sent to another user, wherein the request to the other user includes a document, and wherein the request to the other user is associated with a deadline.

9. The computing device of claim 8, wherein the channel includes an area at the bottom of a document.

10. The computing device of claim 9, wherein the channel includes an entry added to a file list.

11. The computing device of claim 10, wherein the file list includes a file folder.

12. The computing device of claim 10, wherein the file list includes a recently opened files list.

13. The computing device of claim 10, wherein the file list includes an email attachment list.

14. The computing device of claim 8, wherein the list of links is in-line with another list in the document, and wherein the list of links is visually distinguished from the other list in the document.

15. A method for intelligent targeting of files needing attention, the method comprising:
receiving data indicating whether each of a group of users has interacted with each of a plurality of documents;
determining a percentage of documents that each of the group of users has interacted with based on the received data;
calculating an average of the percentages;
calculating a standard deviation of the percentages;
identifying a user of the group of users that has interacted with a smaller percentage of the plurality of documents than a defined threshold;
selecting a channel over which to promote a document that the user has not interacted with, wherein the channel includes a location within an application used by the user;
displaying in the location within the application a list of links including the document that the user has not interacted with;
receiving an activation of the link; and
opening the document that the user has not interacted with in response to the activation of the link.

16. The method of claim 15, wherein the received data includes a degree of interaction for each combination of user and document.

17. The method of claim 16, wherein the degree of interaction is based on whether a document was read, scrolled to the bottom, edited, or added to.

18. The method of claim 16, wherein the percentage of documents that each of the group of users has interacted with is modified to incorporate the degree of interaction.

19. The method of claim 15, wherein the list of links is prioritized based on a surrounding content in the application where the list of links is displayed.

20. The method of claim 15, wherein the list of links is prioritized based on an urgency, wherein the urgency is proportional to a proximity of a pending deadline.
